(19) United States
(12) Patent Application Publication
(10) Pub. No.: US 2025/0118979 A1
(43) Pub. Date: Apr. 10, 2025

(54) POWER SUPPLY APPARATUS FOR SUPPLYING POWER JOINTLY WITH A BATTERY UNIT AND A SUPERCAPACITOR

(71) Applicant: YUNG-SHENG HUANG, New Taipei City (TW)

(72) Inventor: YUNG-SHENG HUANG, New Taipei City (TW)

(21) Appl. No.: 18/378,201

(22) Filed: Oct. 10, 2023

(51) Int. Cl. H02J 7/00; H02J 7/34

(52) U.S. Cl. CPC H02J 7/0063; H02J 7/345; H02J 2207/20

(57) ABSTRACT

A power supply apparatus is proposed for use with a load of the type that requires an initial instant large current for quick startup, such as the startup motor for an automobile engine. The proposed power supply apparatus is characterized in that a battery unit is jointly used with a supercapacitor for preforming a joint battery-supercapacitor discharging process, whereby when the load is being started, a switch unit such as a relay is turned to ON state to allow the battery unit and the supercapacitor to concurrently supply power with an initial instant large current such that the load can be quickly started. In the application on automobiles, the proposed power supply apparatus can replace traditional lead-acid batteries for supplying power to the startup motor of the automobile engine, thus allowing the startup motor to produce a more powerful and rapid accelerating force for quick startup of the automobile engine.

### BACKGROUND OF THE INVENTION

### 1. Field of the Invention

The invention relates to power supply technology, and more particularly to a power supply apparatus that jointly uses a battery unit in conjunction with a supercapacitor for supplying power to a load of the type that specifically requires an initial instant large current for quick startup, such as the startup motor of an automobile engine.

### 2. Description of Related Art

The automobile is a common and widely used means for transportation which is typically powered by a gasoline-based engine. Traditionally, in order to start the automobile engine, a startup motor combined with a lead-acid battery is used, where the battery is used for supplying power to the startup motor which is then used to drive the engine for ignition and startup.

One problem in the use of the lead-acid battery for supplying power to the engine startup motor, however, is that it has a slow discharging and charging speed and is only able to supply a small amount of current at the initial instance when the battery is connected to the load. Therefore, as an undesired result, the small initial current can only drive the startup motor to produce a small accelerating force, which results in a slow startup of the automobile engine.

In view of the above-mentioned problem, there exists therefore a need in the automobile industry for a solution that can be used for supplying power with an initial instant large current to the automobile engine startup motor so as to allow the startup motor to produce an initially more powerful and rapid accelerating force for quick startup of the automobile engine.

### SUMMARY OF THE INVENTION

It is therefore the primary objective of this invention to provide a solution to the above-mentioned problem which can be used to replace traditional lead-acid batteries for supplying power with an initial instant large current to the automobile engine startup motor such that the startup motor can produce an initially more powerful and rapid accelerating force for quick startup of the automobile engine.

However, broadly speaking, the power supply apparatus of the invention is not limited to the application on the startup motor of an automobile engine, and rather can be broadly used to supply power to any type of load that requires an initial instant large current for quick startup.

In architecture, the power supply apparatus of the invention comprises the following constituent elements: (a) a battery unit; (b) a supercapacitor; (c) a switch unit; (d) a voltage buck/boost converter unit; (e) a load-start monitoring unit; (f) a supercapacitor-voltage monitoring unit; and (g) a main control unit.

In operation, when the load is started, the power supply apparatus of the invention is capable of performing a joint battery-supercapacitor discharging process that jointly uses both the battery unit and the supercapacitor to discharge and supply power to the load, wherein the supercapacitor is used to supply an initial instant large current for quick startup of the load.

After each engine startup operation, the power supply apparatus of the invention will inspect whether the output voltage of the supercapacitor is greater than the preset rated voltage level. If NOT, the power supply apparatus of the invention will then perform a supercapacitor-recharging process, whereby the battery unit is used to recharge the supercapacitor such that in the next time when the load is to be started, the supercapacitor has the capacity to supply an initial instant large current to the load.

Therefore, in the application on an automobile engine, the invention represents a solution to the problem aforementioned in the background section and thus can be used to replace traditional lead-acid batteries for supplying power to the automobile engine startup motor, characterized in that the supplied power includes an initial instant large current that allows the startup motor to produce a more powerful and rapid accelerating force for quick startup of the automobile engine.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the power supply apparatus of the invention when connected to a load;

FIG. 2 is a schematic diagram showing an example of a practical application of the power supply apparatus of the invention for an automatable engine;

FIG. 3 is a schematic diagram showing the fundamental architecture of the power supply apparatus of the invention;

FIG. 4A is a waveform diagram showing the electrical charging and discharging characteristics of a typical lithium battery unit;

FIG. 4B is a waveform diagram showing the electrical charging and discharging characteristics of a supercapacitor;

FIG. 5 is a schematic diagram showing an embodiment of the internal circuit architecture of a voltage buck/boost converter unit utilized by the power supply apparatus of the invention;

FIG. 6 is a schematic diagram showing the voltage buck/boost converter unit of

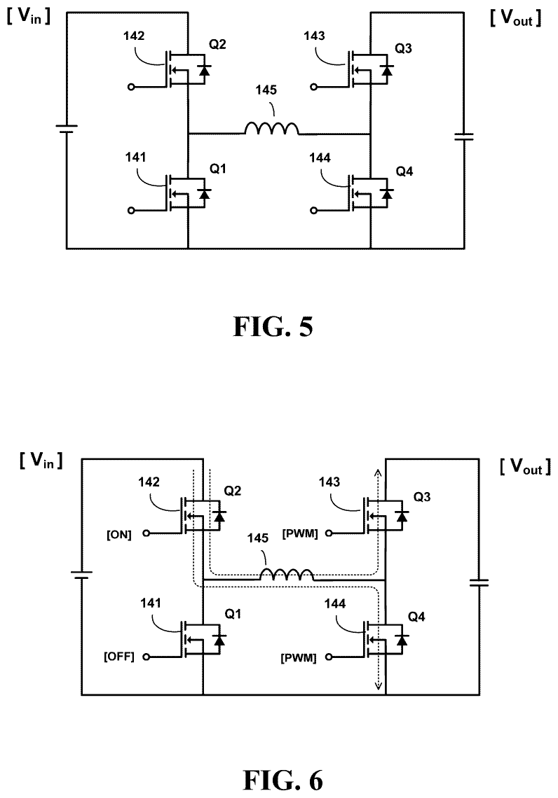

FIG. 5 when operating in a voltage buck/boost mode; and; and

FIG. 7 is a flow diagram showing the procedural steps performed by a main control unit utilized by the power supply apparatus of the invention.

### DETAILED DESCRIPTION OF PREFERRED EMBODIMENTS

The present invention proposes a novel power supply apparatus that jointly uses a battery unit in conjunction with a supercapacitor for supplying power to a load, which is disclosed in full details by way of preferred embodiments in the following with reference to the accompanying drawings.

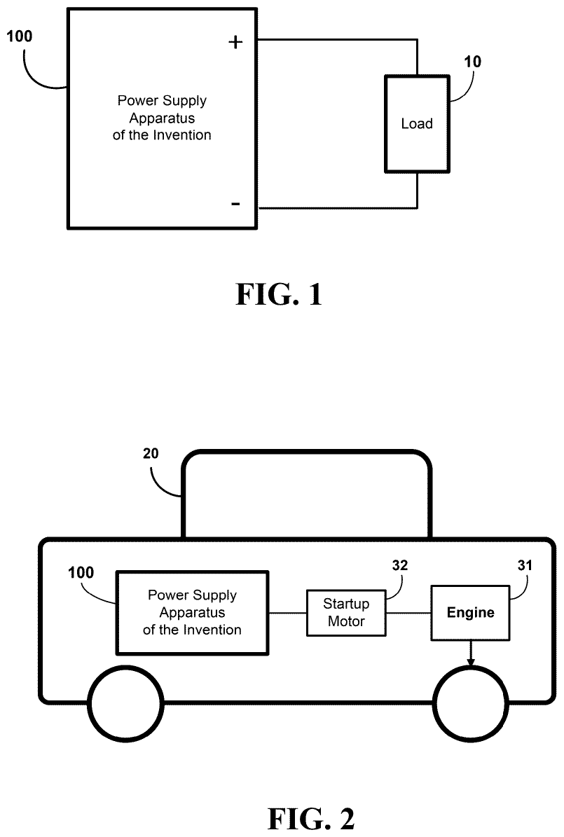

FIG. 1 is a schematic diagram showing the application of the power supply apparatus of the invention which is represented here by a box indicated by the reference numeral 100. As shown, in application, the power supply apparatus of the invention 100 is connected to a load 10 which is specifically a type of load that requires an initial instant large current for quick startup at the initial instance of time when the load 10 is being turned on, such as the startup motor for an automobile engine.

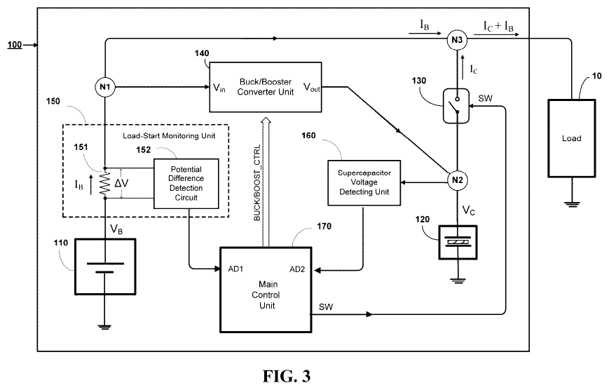

FIG. 2 shows an example of the application of the power supply apparatus of the invention 100 on an automobile 20. As shown, the automobile 20 is equipped with an engine 31 and a startup motor 32, wherein the engine 31 is used to drive the automobile 20, while the startup motor 32 is used for ignition and startup of the engine 40. Since the startup motor 32 requires an initial instant large current for quick startup, it is the purpose of the power supply apparatus of the invention 100 to supply this kind of power to the startup motor 31. Therefore, in this example, the startup motor 31 shown in FIG. 2 serves as the load 10 shown in FIG. 1.

However, broadly speaking, the power supply apparatus of the invention 100 is not limited to the application on an automobile engine startup motor shown in FIG. 2, and rather can be broadly used to supply power to any type of load that requires an initial instant large current for quick startup.

FIG. 3 shows the fundamental architecture of the power supply apparatus of the invention 100, which comprises: (a) a battery unit 110; (b) a supercapacitor 120; (c) a switch unit 130; (d) a voltage buck/boost converter unit 140; (e) a load-start monitoring unit 150, which is composed of a resistor 151 and a potential-difference detecting circuit 152; (f) a supercapacitor-voltage monitoring unit 160; and (g) a main control unit 170. The functions and configurations of these constituent elements are respectively described in details in the following.

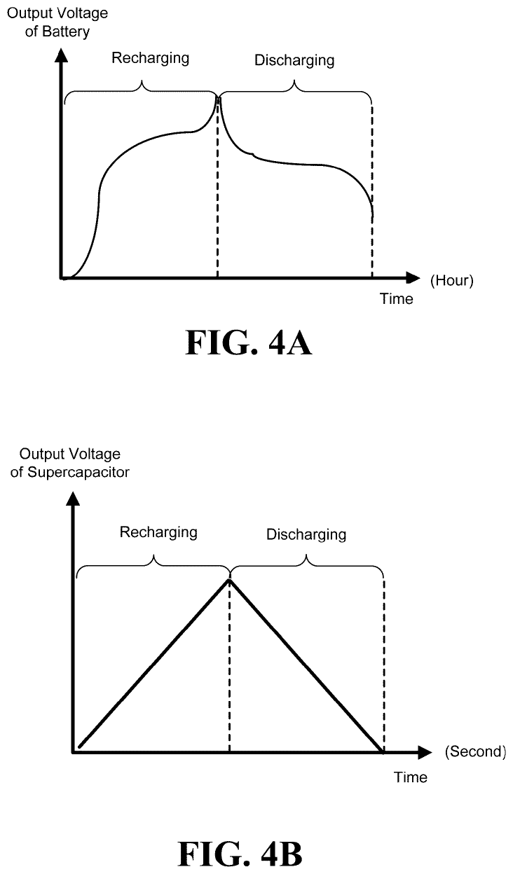

The battery unit 110 can be any type of battery, such as a rechargeable lithium battery, that can supply a dynamic DC current. In this specification, the output voltage and current of the battery unit 110 are respectively denoted by V_{B} and I_{B}. In operation, the battery unit 110 is used to supply an output current I_{B} to the load 10. In configuration, the battery unit 110 is connected to the resistor 151 which is connected onward to a first node N1 for connection to two branching routes. The first branching route is connected directly to the load 10, while the second branching route is connected to the input port Vᵢₙ of the voltage buck/boost converter unit 140. FIG. 4A is a waveform diagram showing the discharging and recharging characteristics of a typical lithium battery that serves as the battery unit 110. It can be seen from this diagram that the lithium battery has the disadvantage that it is unable to supply an initial instant large current at the initial instance of time when it is connected to the load 10, and rather is only able to slowly supply a small amount of current. The advantage of the lithium battery, however, is that it has a large storage capacity to supply power continuously for an elongated period of time, typically several hours.

The supercapacitor 120 is also called ultracapacitor, which is a special type of capacitor that has a super-capacitance much larger than ordinary capacitors, which is defined here as a capacitance that is as much as or greater than 0.1 farad (F). In this specification, V_{C0} is used to denote a preset rated output voltage of the supercapacitor 120 when charged to full capacity, whereas V_{C} and I_{C} are used respectively to denote the real-time output voltage and current of the supercapacitor 120 during actual operation. In configuration, the supercapacitor 120 is connected to a second node N2 which is further connected to three branching routes, wherein the first branching route is connected to the switch unit 130, the second branching route is connected to the output port Vₒᵤₜ of the voltage buck/boost converter unit 140, and the third branching route is connected to the supercapacitor-voltage monitoring unit 160. Based on this configuration, when the switch unit 130 is turned to ON state, it will electrically connect the supercapacitor 120 to the load 10, thereby allowing the supercapacitor 120 to supply an instant large current I_{C} via the switch unit 130 to the load 10. FIG. 4B is a waveform diagram showing the discharging and recharging characteristics of the supercapacitor 120. It can be seen from this diagram that the supercapacitor 120 has the advantage that when initially connected to the load 10, it is able to supply an initial instant large current. Moreover, in recharging operation, the supercapacitor 120 can be recharged to full capacity very quickly. However, the disadvantage of the supercapacitor 120 is that it can supply power only for a very short period of time, typically only several seconds.

The switch unit 130 is connected between the second node N2 and a third node N3, where the third node N3 is connected directly to the load 10. In operation, the ON/OFF state of the switch unit 130 is controlled by a switch-control signal SW from the main control unit 170. When the switch unit 130 is turned to ON state, it will electrically connect the supercapacitor 120 via the third node N3 to the load 10, thereby allowing the supercapacitor 120 to discharge and thus supply an initial instant large current I_{C} via the switch unit 130 to the load 10. On the other hand, when the switch unit 130 is turned to OFF state, it will disconnect and thus electrically isolate the supercapacitor 120 from the load 10. In practical implementation, the switch unit 130 can be any suitable type of power switch, such as an electromechanical relay, a solid-state relay (SSR), or a transistor-based electronic switch.

The voltage buck/boost converter unit 140 has an input port Vᵢₙ and an output port Vₒᵤₜ, wherein the input port Vᵢₙ is connected to the first node N1 for receiving the output voltage V_{B} of the battery unit 110, while the output port Vₒᵤₜ is connected to the second node N2 for transferring the output voltage of the voltage buck/boost converter unit 140 to the supercapacitor 120. In operation, the voltage buck/boost converter unit 140 is controlled by a buck/boost control signal BUCK/BOOST_CTRL form the main control unit 170 to perform a buck/boost operation on the output voltage V_{B} of the battery unit 110. The buck/boost converted output voltage Vₒᵤₜ is then transferred to the supercapacitor 120 for recharging the supercapacitor 120.

In practice, the voltage buck/boost converter unit 140 can be implemented in various ways. A preferred embodiment is a four-transistor type of voltage boost/buck convertor circuit shown in FIG. 5, which is composed of a first transistor (Q1) 141, a second transistor (Q2) 142, a third transistor (Q3) 143, a fourth transistor (Q4) 144, and a inductor 145.

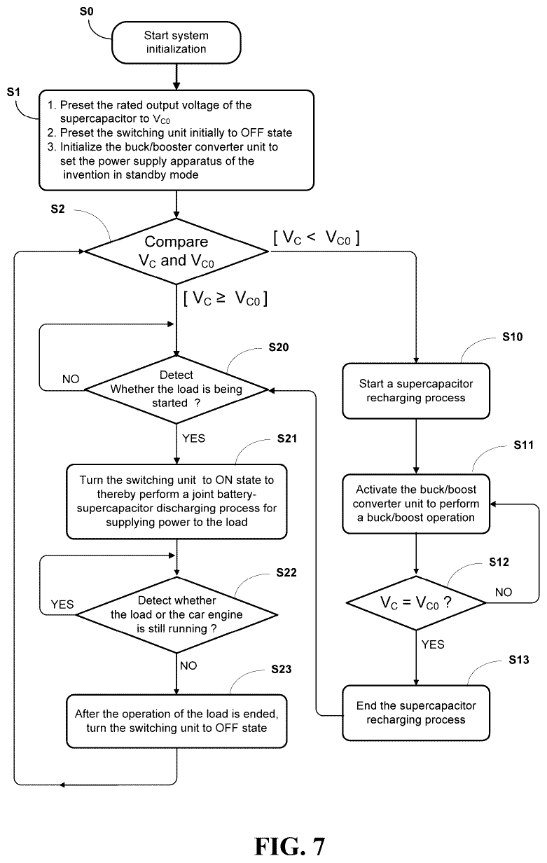

In operation, the voltage boost/buck convertor circuit shown in FIG. 5 is used to perform a buck/boost operation on the output voltage V_{B} of the battery unit 110 as depicted in FIG. 6. As shown, the buck/boost operation is controlled by a buck/boost control signal BUCK/BOOST_CTRL from the main control unit 170, which includes four control signals (PWM, PWM, ON, OFF) respectively used to control the ON/OFF states of the four transistors (Q1, Q2, Q3, Q4), where PWM is a train of pulses used for pulse-wide modulation (PWM) to implement the voltage buck/boost operation. The buck/boost operation is applied to the output voltage V_{B} of the battery unit 110 and the buck/boost converted output voltage Vₒᵤₜ is subsequently transferred to the supercapacitor 120 for recharging the supercapacitor 120.

Since the circuit structure and operations shown in FIG. 5 and FIG. 6 are conventional and well-known technology, details thereof will not be described in this specification.

The load-start monitoring unit 150 is connected between the battery unit 110 and the load 10 for monitoring whether the load 10 is being started. In practice, for example, the load-start monitoring unit 150 is implemented with a resistor 151 and a potential-difference detecting circuit 152, wherein the resistor 151 is connected between the battery unit 110 and the first node N1, and the potential-difference detecting circuit 152 is used to detect the potential difference (denoted by AV) across the resistor 151. When the load 10 is in idled state, since at this time the battery unit 110 is unconnected to the load 10, there is no current flowing through the resistor 151, thus causing ΔV=0. On the other hand, when the load 10 is being started, since at this time the battery unit 110 is electrically connected to the load 10, it will supply an output current I_{B} via the resistor 151 to the load 10, thus causing the occurrence of a potential difference across the resistor 151, i.e., ΔV≠0. Therefore, the potential difference ΔV across the resistor 151 can be used as a signal that indicates whether the load 10 is being started. The potential difference ΔV can be detected by the potential-difference detecting circuit 152 which then transfers the detected signal in analog form to the main control unit 170 where the analog signal is converted to digital form (denoted by AD1) to indicate that the load 10 is being started.

The supercapacitor-voltage monitoring unit 160 is connected via the second node N2 to the supercapacitor 120 for monitoring the real-time output voltage V_{C} of the supercapacitor 120 during actual startup operation. In practice, the supercapacitor-voltage monitoring unit 160 is a voltage-sensing circuit which can sense the magnitude of V_{C} and transfers the detected magnitude in analog form to the main control unit 170 for conversion into a digital signal (denoted by AD2) that indicates the magnitude of V_{C}.

The main control unit 170 is used to control the overall operation of the power supply apparatus of the invention 100. In configuration, the main control unit 170 is connected to the switch unit 130, the voltage buck/boost converter unit 140, the load-start monitoring unit 150, and the supercapacitor-voltage monitoring unit 160. In operation, the main control unit 170 receives the AD1 signal (which indicates that the load 10 is being started) from the load-start monitoring unit 150 and the AD2 signal (which indicates the real-time output voltage V_{C} of the supercapacitor 120 during operation) from the supercapacitor-voltage monitoring unit 160, and responds to the AD1 and AD2 signals by generating a switch-control signal SW to control the ON/OFF state of the switch unit 130 and a buck/boost control signal BUCK/BOOST_CTRL to control the operation of the voltage buck/boost converter unit 140. When activated, the main control unit 170 performs two processes: a joint battery-supercapacitor discharging process and a supercapacitor-recharging process, wherein the joint battery-supercapacitor discharging process is used to allow the battery unit 110 and the supercapacitor 120 to jointly and concurrently supply power to the load 10, while the supercapacitor-recharging process is used to recharge the supercapacitor 120 to full capacity after being discharged. The procedural steps performed by the main control unit 170 for controlling the operation of the power supply apparatus of the invention 100 will be described later in the following with reference to FIG. 7. In practice, the main control unit 170 can be implemented with a microprocessor, such as an embedded microprocessor, or a customized programmable logic circuit, such as ASIC (Application-Specific Integrated Circuit), FPGA (Field Programmable Gate Array), PLD (Programmable Logic Device), PLA (Programmable Logic Array), or PAL (Programmable Array Logic), to name just a few.

Details about the overall operation of the power supply apparatus of the invention 100 for supplying power to the load 10 will be described in the following with reference to the flow diagram of FIG. 7.

In application, the power supply apparatus of the invention 100 is used for coupling to a load 10, such as the startup motor 32 for an automobile engine 31. When the load 10 is started, the power supply apparatus of the invention 100 will respond by performing a joint battery-supercapacitor discharging process whereby the battery unit 110 and the supercapacitor 120 are jointly and concurrently used to supply electric power to the load 10, wherein the supercapacitor 120 is used to supply an initial instant large current I_{C}, while the battery unit 110 is used to supply an output current I_{B} As a result, the power received by the load 10 is a combined current of I_{C}+I_{B}, rather than just I_{B} in the case of the prior art, such that the load 10 can be quickly started.

When the power supply apparatus of the invention 100 is put into operation, it will initiate the main control unit 170 to perform a control procedure shown in the flow diagram of FIG. 7, which includes a series of procedural steps as described in the following.

In step (S0), the main control unit 170 starts an initialization procedure.

In step (S1), the main control unit 170 performs the following three steps for the initialization procedure:
(1) preset a value for V_{C0}, where V_{C0} represents the rated output voltage of the supercapacitor 120 when charged to full capacity;
(2) preset the switch unit 130 to OFF state;
(3) initialize the voltage buck/boost converter unit 140 so as to set the power supply apparatus of the invention 100 in a standby mode to monitor whether the load 10 is being started.

In step (S2), the main control unit 170 continues to monitor the magnitude of V_{C} detected by the supercapacitor-voltage monitoring unit 160, where V_{C} indicates the real-time output voltage of the supercapacitor 120, and then compares V_{C} against V_{C0} to decide which action is to be taken in the next step, as follows:
(Condition 1) If (V_{C}<V_{C0}), the procedure goes to step (S10).
(Condition 2) If (V_{C}≥V_{C0}), the procedure goes to step (S20).

In step (S10), since the condition of (V_{C}<V_{C0}) indicates that the charge currently stored in the supercapacitor 120 is below V_{C0} and thus insufficient to supply an instant large current I_{C} for the load 10, the main control unit 170 starts a supercapacitor-recharging process.

In step (S11), the main control unit 170 issues a buck/boost control signal BUCK/BOOST_CTRL to the voltage buck/boost converter unit 140 while maintaining the switch unit 130 in OFF state. The BUCK/BOOST_CTRL signal controls the voltage buck/boost converter unit 140 to perform a buck/boost operation on the output voltage V_{B} of the battery unit 110, and then use the converted output voltage Vₒᵤₜ to recharge the supercapacitor 120.

In step (S12), during the supercapacitor-recharging process, the main control unit 170 continues to compare V_{C} against V_{C0} in the following manner:
(Condition 1) If (V_{C}<V_{C0}), it indicates that the supercapacitor 120 hasn't been fully charged to the preset rated voltage V_{C0}, and therefore the step (S12) is continued.
(Condition 2) If (V_{C}=V_{C0}), it indicates that the supercapacitor 120 has been recharged to full capacity, and therefore the procedure goes to step (S13).

In step (S13), the main control unit 170 ends the supercapacitor-recharging process and then jumps to step (S20).

In step (S20), the main control unit 170 is set to monitor whether the load 10 is being started by checking whether the load-start monitoring unit 150 issues the AD1 signal when the potential-difference detecting circuit 152 detects the occurrence of a potential difference ΔV across the resistor 151. If NO, it indicates that the load 10 is currently in idled state and unstarted, and therefore the step (S20) is continued. On the other hand, if YES, the procedure goes to step (S21)

In step (S21), the main control unit 170 issues a switch-control signal SW to turn the switch unit 130 to ON state, thereby allowing the supercapacitor 120 and the battery unit 110 to concurrently supply power to the load 10, wherein the supercapacitor 120 is used to supply an initial instant large current I_{C}, while the battery unit 110 is used to supply a battery output current I_{B}. As a result, the power received by the load 10 is a combined current of I_{C}+I_{B}, rather than just I_{B} in the case of the prior art, such that the load 10 can be more quickly started than the prior art.

In step (S22), the main control unit 170 continues to monitor whether the load 10 (the engine 31 on the automobile 20) is still in operation. If YES, the main control unit 170 continues step (S22). On the other hand, if NO, it indicates that the operation of the load 10 is completed and ended, and therefore the procedure jumps to step (S23).

In step (S23), since the operation of the load 10 is ended, the main control unit 170 issues a switch-control signal SW to the switch unit 130 to turn the switch unit 130 to OFF state, thereby disconnecting the supercapacitor 120 from the load 10. After this, the procedure jumps to step (S2).

In step (S2), the main control unit 170 checks the real-time output voltage V_{C} of the supercapacitor 120, and compares V_{C} against V_{C0}. Since at this time the supercapacitor 120 has completely discharged, it results in the condition of (V_{C}<V_{C0}). Therefore the procedure goes to the steps (S10) through (S13) to perform a supercapacitor-recharging process, whereby the battery unit 110 is used to supply power via the voltage buck/boost converter unit 140 to the supercapacitor 120 for recharging the exhausted supercapacitor 120 back to its preset rated voltage V_{C0}. As a result, in the next time when the load 10 is started, the supercapacitor 120 has the full capacity to supply an initial instant large current I_{C} to the load 10. After the supercapacitor-recharging process is completed, the procedure returns to step (S20) to wait for the next start of the load 10.

In conclusion, the power supply apparatus of the invention 100 is capable of supplying power to the load 10 by jointly using the battery unit 110 and the supercapacitor 120, wherein the supercapacitor 120 is used to supplying an initial instant large current I_{C}, while the battery unit 110 is used to supply a battery output current I_{B}. As a result, the load 10 will receive a combined current (I_{C}+I_{B}), rather than just I_{B} in the case of the prior art, such that the load 10 can be quickly started. Since the supercapacitor 120 is fully discharged after each startup operation, the power supply apparatus of the invention 100 will then use the battery unit 110 to recharge the supercapacitor 120, such that in the next time the load 10 is started, the supercapacitor 120 has the capacity again to supply an initial instant large current I_{C} to the load 10.

In the application on an automobile engine, the invention therefore represents a solution to the problem aforementioned in the background section and thus can be used to replace traditional lead-acid batteries for supplying power with an initial instant large current to the startup motor of the automobile engine, thereby allowing the startup motor to produce a more powerful and rapid accelerating force for quick startup of the automobile engine.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A power supply apparatus for use with a load for supplying power to the load, comprising:
(a) a battery unit for supplying a battery output current;
(b) a supercapacitor having a preset rated output voltage;
(c) a switch unit, which is switchably connected between the supercapacitor and the load;
(d) a voltage buck/boost converter unit having an input port and an output port, wherein the input port is connected to the battery unit and the output port is connected to the supercapacitor for performing a buck/boost operation on the output voltage of the battery unit to generate a buck/boost converted output voltage for use to recharge the supercapacitor;
(e) a load-start monitoring unit, which is connected between the battery unit and the load for monitoring whether the load is being started;
(f) a supercapacitor-voltage monitoring unit, which is connected to the supercapacitor for monitoring real-time output voltage of the supercapacitor during operation; and
(g) a main control unit, which is connected to the load-start monitoring unit, the supercapacitor-voltage monitoring unit, the switch unit, and the voltage buck/boost converter unit, and which is configured to be initiated after the load-start monitoring unit has detected that the load is being started for performing a joint battery-supercapacitor discharging process and a supercapacitor-recharging process;
wherein the joint battery-supercapacitor discharging process is performed in such a manner that the main control unit issues a switch-control signal to turn the switch unit to ON state, thereby allowing the battery unit and the supercapacitor to jointly and concurrently discharge and supply power to the load; and
wherein the supercapacitor-recharging process is performed after the joint battery-supercapacitor discharging process in such a manner that when the main control unit determines that the real-time output voltage of the supercapacitor is lower than the preset rated output voltage thereof, the main control unit issues a buck/boost control signal to the voltage buck/boost converter unit, thereby activating the voltage buck/boost converter unit to perform a buck/boost operation on the output voltage of the battery unit to thereby generate a buck/boost converted output voltage for use to recharge the supercapacitor to the preset rated output voltage.

2. The power supply apparatus as recited in claim 1, wherein the load is a startup motor for an automobile engine.

3. The power supply apparatus as recited in claim 1, wherein the battery unit is a rechargeable lithium battery.

4. The power supply apparatus as recited in claim 1, wherein the switch unit is an electromechanical relay, a solid-state relay (SSR)), or a transistor-based electronic switch.

5. The power supply apparatus as recited in claim 1, wherein the voltage buck/boost converter unit is a four-transistor type of voltage boost/buck circuit.

6. The power supply apparatus as recited in claim 1, wherein the load-start monitoring unit comprises:
a resistor connected between the battery unit and the load; and
a potential-difference detecting circuit for detecting whether there is a potential difference across the resistor to thereby determine whether the load is being started.
